(19) United States
(12) Patent Application Publication
(10) Pub. No.: US 2011/0205677 A1
(43) Pub. Date: Aug. 25, 2011

(54) SWITCH-ON PROTECTION DEVICE FOR AN ELECTRICAL DEVICE THAT CAN BE OPERATED ON A SUPPLY VOLTAGE

(75) Inventors: Pius Studer, Luzern (CH); Stefan Eberli, Hasle (CH)

(73) Assignee: LEISTER PROCESS TECHNOLOGIES, Kägiswil (CH)

(21) Appl. No.: 13/057,572

(22) PCT Filed: Aug. 4, 2009
(86) PCT No.: PCT/EP2009/005632

§ 371 Date: Feb. 19, 2011

(30) Foreign Application Priority Data
Aug. 6, 2008 (DE) 20 2008 010 454.8

(51) Int. Cl. H02H 3/02

(52) U.S. Cl. 361/62

(57) ABSTRACT

The invention relates to a switch-on protection device (1) for an electrical device supplied by a supply voltage, comprising a supply voltage input (2), a switchable electric load (3) and a supply voltage switch (4) arranged in between that can be manually actuated and has the switching positions OFF and ON. The switch-on protection device (1) is arranged in a supply voltage current path to the load (3) and detects the switch position of the supply voltage switch (4) when the supply voltage is applied to the supply voltage input (2). Only in the OFF switching position of the supply voltage switch (4) does it allow closing of the supply voltage path to the electric load (3). By means of two sensor circuits (10, 11), the supply voltage current path is scanned on the input and output sides of the supply voltage switch (4), wherein the output signals thereof are used by an electronic switching element (12) for controlling a semiconductor switching device (6) connected upstream of the load (3). The signal output (Q) of the switching element (12) can assume two stable states that can be reversed by changing the output signals arriving at the two signal inputs (D, CP) of the switching element (12). The switching element (12) reacts to the input signal applied first.

### TECHNICAL FIELD OF THE INVENTION

The invention relates to a switch-on protection device for an electrical device supplied by a supply voltage, comprising a supply voltage input, at least one switchable electric load and a supply voltage switch arranged in between that can be manually actuated and has the switching positions OFF and ON, where the switch-on protection device is arranged in a supply voltage current path from the supply voltage input to the load and detects the switch position of the supply voltage switch when the supply voltage is applied to the supply voltage input, and where only in the OFF switching position of the supply voltage switch does it allow closing of the supply voltage path to the electric load. The switch-on protection device has a first sensor circuit, a second sensor circuit, and an electronic switching element with two inputs and one signal output, with the first sensor circuit providing a first output signal that is derived from the supply voltage current path on the input side of the supply voltage switch, and with the second sensor circuit providing a second output signal that is derived from the supply voltage current path on the output side of the supply voltage switch. The output signals of the sensor circuits are each assigned as input signals to one of the signal inputs of the switching element. In addition, the switch-on protection device comprises a semiconductor switching device that is connected to the signal output of the switching element and switches the supply voltage current path between the supply voltage input and the load downstream from the supply voltage switch depending on the switching signal provided at the signal output.

In terms of safety regarding the switching-on behavior of an electrical device that can be operated on a supply voltage, it is desirable as well as necessary that, when the supply voltage is applied, the electrical device is not automatically put into a switched-on operating condition. Therefore, in order to put it into or take it out of the operating condition, a supply voltage switch that can be manually actuated and is arranged in a supply voltage current path to the load of the device is usually provided.

In most known electrical devices, the switching-on or the switching-off of the load is accomplished either directly via a single or multiple pole supply voltage switch or via an auxiliary switch in conjunction with a relay or a relay switch. It is also known to use electronic switches like thyristors or triacs that are operated via an electronic control circuit with additional auxiliary switch for switching the supply voltage. Frequently, such supply voltage and/or auxiliary switches are implemented as simple toggle switches or pressure switches that remain in their last switching position.

When a supply voltage is applied to the supply voltage input of such devices, with the supply voltage switch or auxiliary switch in switched-on position, the device will operate unintentionally and therefore without supervision, thereby causing an increased safety risk. Such unintended operation may occur, for example, when the supply voltage is temporarily interrupted during the operation of the electrical device and then becomes available again in the absence of an operator, or when the operator connected the electrical device to the supply voltage with the switch being inadvertently in the ON position. This may pose a danger for the user as well as for other persons in the vicinity of the electrical device, and may also cause costly damage to objects in the vicinity of the electrical tool as well as to the tool itself.

### DISCUSSION OF RELATED ART

In order to avoid damage to persons and/or objects, expensive electrical devices are sometimes equipped with electronic protective circuits that are able to detect whether the supply voltage was applied by the actuation of the supply voltage switch or in some other way. Electrical devices with such equipment are usually put into operation only when the device had been switched on by the actuation of the supply voltage or auxiliary switch. As examples, the design patent DE 20 2006 006 508 U1 and the patent DE 196 16 851 B4 serve as references.

The design patent DE 20 2006 006 508 U1 discloses an electrical safety system for electrical tools, with a connection that can be connected to a power supply source, an electrical load provided in an electrical tool, and an ON/OFF switch connected to the load. The safety system prevents electric power from being applied to the switch and/or the load when the ON/OFF switch is in the ON switching position when the device is connected to the line voltage, and permits the application of electric power when the ON/OFF switch is in the OFF switching position. The safety system comprises a safety circuit that is arranged between and connected to the connection and the ON/OFF switch and is designed to detect whether the ON/OFF switch is in the ON switching position or OFF. Depending on the detected switching position, the safety circuit switches the electric power for the ON/OFF switch, only applying the electric power from the connection to the ON/OFF switch when the ON/OFF switch is in the OFF switching position. For this purpose, the safety circuit comprises a monitoring circuit, a relay control circuit, and a switching relay. The switching relay is arranged in a first electrical path to the ON/OFF switch, and the monitoring relay is arranged in a second electrical path between the connection and the switch or the load.

When the connecting device of the electrical tools is connected to the voltage supply, the monitoring circuit detects the switching position of the ON/OFF switch and acts on the relay control in such a way that the electric power is transmitted from the switching relay to the ON/OFF switch only if the ON/OFF switch is switched off. When line voltage is applied to the connecting device and the ON/OFF switch is closed, a low-power test current flows into the second current path that is used for detecting the switching position of the ON/OFF switch. Thus, the safety circuit determines the condition of the downstream switch and itself applies the supply voltage to the switch.

It is considered to be a disadvantage of this re-start protection that, due to the low-power test current, the monitoring circuit does not reliably detect the activated ON/OFF switch, and that the flowing test current itself may already undesirably trigger certain device functions.

The patent DE 196 16 851 B4 teaches a protective device for avoiding an undesirable supply of power for an electrical device that comprises a power switch and can be connected to a power supply. The protective device comprises a first voltage detection circuit that is arranged upstream from the power switch and indicates the presence of a supply voltage by means of a first detection voltage, with the first voltage detection circuit comprising a first integration circuit with a first time constant, and with the first detection voltage reaching a first value after a transition period. In addition, the protective device comprises a second voltage detection circuit that is arranged downstream from the power switch and indicates the presence of a voltage by means of a second detection voltage, with the second voltage detection circuit comprising a second integration circuit with a second time constant, and with the second detection voltage reaching a second value after a transition period. Here, the first time constant is larger than the second time constant, and the first value of the first detection voltage is greater than the second value of the second detection voltage. The protective device comprises a comparator for comparing the first and the second detection voltage, as well as a control device that reacts to the output signal of the comparator and blocks the electrical equipment after an interruption of the power supply, or if the electrical equipment is connected to the power supply while the power switch is switched ON. This blocking takes place during a transition period in which the second detection voltage is greater than the first detection voltage. The comparator is connected to the outputs of the pre- and post-voltage detection circuits. It comprises an inverting input connection that is connected to the output of the pre-voltage detection circuit, as well as a non-inverting input connection that is connected to the output of the post-voltage detection circuit. The comparator generates a comparison signal when comparing the output signals of the first and the second voltage detection circuits. The comparison signal corresponds to a logic “0” level if the output signal of the pre-voltage detection circuit is larger than the output signal of the post-voltage detection circuit. The comparison signal rises to a logic “1” level if the output signal of the post-voltage detection circuit is greater than the output signal of the pre-voltage detection circuit. An electronic switching-off circuit is connected at its input to the output of the comparator and at its output to the electrical equipment. It blocks the electrical equipment if the output signal of the comparator indicates the “1” level, and grants access to the electrical equipment when the output signal of the comparator corresponds to the “0” level.

It is considered to be a disadvantage of this protective device that the two voltage detection circuits are costly because, beside the RC elements, they each require at least one diode and one break-down diode. Also, the analog circuit for maintaining the state of the comparator is relatively costly.

### SUMMARY OF THE INVENTION

With reference to this prior art, the invention addresses the problem of offering an improved method for reliably detecting a supply voltage switch in the ON switching position and without the flow of a current. The information regarding the state of the supply voltage switch is to be provided digitally and fed into a digital semiconductor circuit for controlling the electric load. The invention addresses the additional problem of proposing a hot air device with such a switch-on protection device that can be operated on a supply voltage.

According to the invention, these problems are solved by a switch-on protection device with the characteristics of claim 1 and by a hot air device with the characteristics of claim 7. Further advantageous implementations are given in the related claims.

Accordingly, the switch-on protection device according to the invention for an electrical device that can be operated on a supply voltage comprises an electronic switching element whose signal output may assume two stable states that can be reversed by a change of the input signals at the signal inputs of the control element. For generating the input signals, the switch-on protection device comprises a first sensor circuit that is connected to the supply voltage input or the supply voltage switch on the input side, and a second sensor circuit that is connected to the supply voltage switch on the output side.

In the electrical device that can be operated on a supply voltage, the supply voltage switch that can be actuated manually and has the switching positions OFF and ON is arranged in a supply voltage current path from the supply voltage input to the at least one switchable electric load. The switch-on protection device detects the switching position of the supply voltage switch when the supply voltage is applied to the supply voltage input and permits the closing of the supply voltage current path to the load only when the supply voltage switch is in OFF switching position. To achieve this, the switch-on protection device uses the first and the second sensor circuit as well as the electronic switching element with the two signal inputs and with the at least one signal output. When the supply voltage is applied to the supply voltage input, the first sensor circuit provides a first output signal that is derived from the supply voltage current path on the input side of the supply voltage switch. When the supply voltage is switched through via the supply voltage switch, the second sensor circuit provides a second output signal that is derived from the supply voltage current path on the output side of the supply voltage switch. The output signals of the sensor circuits are each associated as input signal with one of the signal inputs of the electronic switching element. In addition, the switch-on protection device comprises a semiconductor switching device that is connected to the signal output of the switching element and switches the supply voltage current path between the supply voltage input and the load downstream from the supply voltage switch depending on a switching signal provided at the signal output.

The electronic switching element of the switch-on protection device according to the invention does not itself switch the supply voltage but only passes on information in the form of signals to the downstream semiconductor switching device. The semiconductor switching device may comprise an electronic flicker circuit that can act on the semiconductor switches, for example triacs or thyristors. As a consequence, as an electronic component, the switch-on protection device is easy to integrate in existing devices. The detection of the switching position of the manually actuated supply voltage switch is essentially accomplished without current, specifically without a test current that flows through the at least one electric load. The sensor circuits merely pick up electronic signals that are applied to the switching element, are passed by it and then passed on to the semiconductor switching device. Here, it may be necessary to provide between the switching element and the semiconductor switching device a switching transistor that may be a part of the switch-on protection device or a part of the semiconductor switching device. The switch-on protection device is intended for an electrical device that can be operated on a supply voltage, either in a fixed location and/or as a mobile device. The supply voltage input may be connected or connectable to the supply voltage either permanently by means of terminals or non-permanently by means of a plug connector.

If a supply voltage is applied via the supply voltage input to the electrical device with the supply voltage switch in the OFF position, the signal output of the electronic switching element assumes that one of the two stable states in which the switching signal issuing from the signal output causes the semiconductor switching device to close the supply voltage current path to the load. When the supply voltage switch is switched from the OFF switching position to the ON switching position, the load receives the supply voltage. Because the electronic switching element acts like a storage element and reverses the state of the signal output in correspondence to a sweeping stage only if a change of the determinative input signal occurs, the second input signal provided later by the second sensor circuit to the second signal input effects no change of the state of the switching element at the signal output and, therefore, the switching condition of the semiconductor switching device.

However, if a supply voltage is applied via the supply voltage input to the electrical device with the supply voltage switch in the ON position, the switch-on protection device reacts immediately. For this purpose, the signal output of the electronic switching element assumes that one of the two stable states in which the switching signal issuing from the signal output does not close the supply voltage current path from the supply voltage switch to the load via the semiconductor switching device. In order to achieve this, the output signal of the first sensor circuit is applied to the switching element with a delay in relation to the output signal of the second sensor circuit. Thus, the second output signal determines the state of the signal output of the switching element. Since, as stated before, the electronic switching element reverses the state of the signal output only if a change of the determinative input signal occurs, the first output signal coming from the first sensor circuit and reaching the first signal input of the switching element slightly later does not effect a change of the state of the switching element and, therefore, the switching condition of the semiconductor switching device.

If the switch-on protection device has reacted and has prevented the closing of the supply voltage current path from the supply voltage switch to the electric load, the blockage of the supply voltage by the switch-on protection device can be lifted by switching the supply voltage switch briefly from the ON switching position to the OFF switching position. After that, it is possible to switch the electrical device on again as usual with the supply voltage switch.

Advantageously, the first and the second sensor circuit comprise first and second RC elements that transmit the signals that originate from the supply voltage switch and are tapped at the output side of the semiconductor switching device and the supply voltage input with different degrees of delay to the signal inputs of the switching element. When the electrical device is connected to the supply voltage input, there will therefore always be a time delay, brief as it may be, between the two signals at the switching element, and this delay is detected and the output signal of the signal output of the switching element depends on it. The output signal that is provided to the semiconductor switching device as switching signal is present in a stable state at the signal output. If, with the supply voltage switch in open condition, supply voltage is applied to an electrical device equipped with the switch-on protection device according to the invention, the signal picked up from the supply voltage input will be the first one to be present at the switching element, and thereby generate an output signal at the signal output. This tells the semiconductor switching device that, after closing the supply voltage switch, it has permission to close the current path to the at least one load so that the electrical device is able to operate. If, on the other hand, supply voltage is applied to the supply voltage input with the supply voltage switch in closed condition, the signal picked up downstream of the supply voltage switch is delayed for a shorter period than the signal tapped at the supply voltage input. The signal from the supply voltage switch will then be the first one to be present at the switching element and will prevent an output signal at its signal output. This tells the semiconductor switching device that it does not have permission to close the current path to the at least one load so that the electrical device is not able to operate. Depending on the specific embodiment, the switch-on protection device and the semiconductor switching device may be implemented as structurally separate electronic control devices that act jointly, or may be combined in a single electronic control unit for the device to be protected that may, for example, comprise a microcontroller as the central control element.

In one embodiment of the invention, the switching element is a flip-flop circuit. The flip-flop circuit may be structured as an integrated circuit or also discretely as a transistor-transistor logic element. Such a switching element is also known as a bi-stable sweep stage and is an electronic circuit that is able to assume two stable states that can be determined at an output. Signals at the inputs switch between these states. Usually, besides the two inputs, two outputs are provided whose state differs logically, i.e. is inverted.

It proved to be advantageous to use a D-flip-flop. This is an edge-controlled flip-flop. Such flip-flops comprise a data input and a clock input as signal inputs. With an active edge, the D-flip-flop stores the logic state of the input and puts out its value at the output. If an active edge is not present, the input value is not picked up.

In the switch-on protection device according to the invention, when the edge of the signal at the clock input is positive, the D-flip-flop transmits the value of the data input to the data output. If, with the supply voltage main switch switched OFF, the electrical device is connected to the supply voltage, first a signal reaches the data input of the flip-flop and no edge reaches its clock input so that the signal from the data input is not transmitted to the output of the D-flip-flop. If the supply voltage main switch is then switched ON, a positive edge reaches the clock input as a signal via the upstream RC element, which causes the signal already present at the data input to be passed to the output of the D-flip-flop, thereby signaling the downstream semiconductor switching device that the device may now start up. Accordingly, the semiconductor switching device closes the supply voltage current path to the load. If, on the other hand, the device is connected to the supply voltage with the main switch switched ON, the signal for the clock input is delayed less than the signal for the data input, i.e. the edge at the clock input of the D-flip-flop rises faster because of the different RC element than at the data input. Because the signal at the data input is still small when the flip-flop is switched, a “0” value will always be passed on to the data output, which signals the downstream semiconductor switching device that the device must not start up. In this case, the semiconductor switching device does not close the supply voltage current path to the load. With an activated re-start protection, in order to be able to operate the device, it is necessary to switch the supply voltage main switch to the OFF switching position for a certain period and then to the ON switching position again.

In an advantageous embodiment of the switch-on protection device according to the invention, an electro-optical display is provided downstream from the switching element that indicates which signal input of the switching element was the first to receive a signal when the supply voltage was applied to the supply voltage input. This display may consist of one or several LEDs, for example. The at least one LED signals whether the switch-on protection device has reacted or not.

The hot air device according to the invention can be operated on a supply voltage and has at least one supply voltage input, at least one switchable electric load in the form of a heating device, as well as a supply voltage switch that can be actuated manually for switching the electric load and that is arranged in series with the supply voltage input and the heating device. In addition, the hot air device comprises a switch-on protection device with the characteristics described above according to the claims 1-6.

Below, the invention is explained in detail with reference to embodiments illustrated in the drawing. Additional characteristics of the invention may be given in the following description of the embodiments of the invention in conjunction with the claims and the attached drawing. The individual characteristics may be realized either individually by themselves or in combinations of several in different embodiments of the invention.

### BRIEF DESCRIPTION OF THE DRAWINGS

FIG. 1 shows a general block schematic of the switch-on protection device according to the invention;

FIG. 2 shows two circuits corresponding to the block schematic in FIG. 1; and

FIG. 3 shows two hot air devices according to the invention with switch-on protection device.

### DETAILED DESCRIPTION OF THE INVENTION

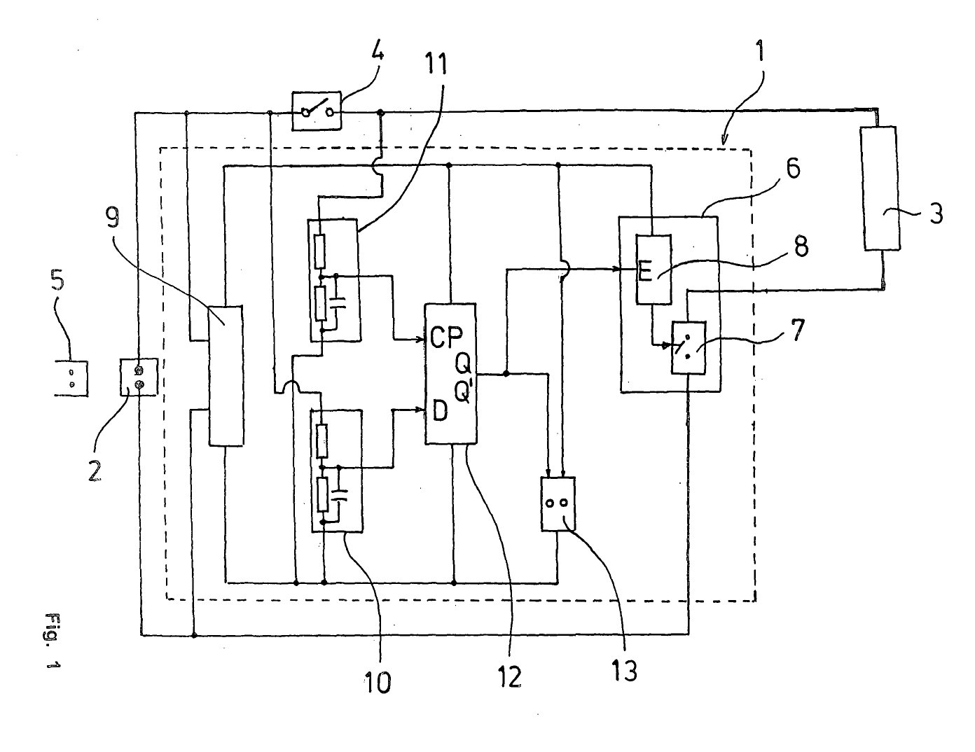

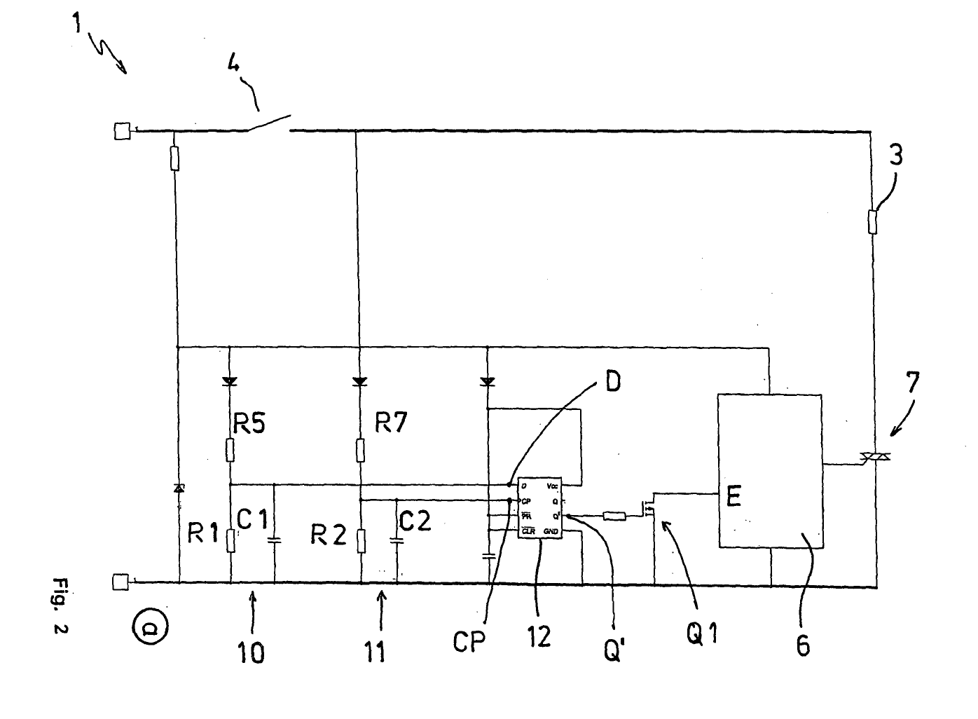

FIG. 1 shows an electronic circuit of the switch-on protection device 1 according to the invention as a block schematic. The switch-on protection device 1 shown here comprises a supply voltage input 2, a switchable electric load 3, and a supply voltage switch 4 that can be actuated manually arranged in between. The supply voltage switch 4 does not switch the electric power of a voltage supply system 5 connected to the supply voltage input 2 directly to the load 3 but indirectly via a semiconductor switching device 6 that is arranged upstream of the load 3 in the supply voltage current path. The semiconductor switching device 6 is an “electronic relay” comprising a semiconductor switch 7 in the form of a thyristor or a triac as well as an associated electronic control system 8 for switching the semiconductor switch 7. The electronic control system 8 may consist of a flicker circuit, for example, which, with the supply voltage applied to the supply voltage input 2 and the supply voltage switch closed, is able to switch the electric power looped to the semiconductor switch 7 through to the load 3. For this purpose, supply voltage is applied to the electronic control system 8 via the supply voltage switch 4.

The switch-on protection device 1 is arranged parallel to the supply voltage switch 4 in a supply voltage current path and detects the ON or OFF switching position of the supply voltage switch 4 when the supply voltage is applied to the supply voltage input 2. It acts on the electronic control system 8 of the semiconductor switching device 6 and prevents it from closing the supply voltage current path via the semiconductor switch 7 to the load 3 when the supply voltage switch 4 is in the ON switching position and supply voltage is applied to the supply voltage input 2.

For this purpose, the switch-on protection device 1 comprises four essential electronic functional elements. First, directly behind the supply voltage input 2, a power supply 9 is arranged that reduces the supply voltage to the usual operating voltage for the subsequent functional elements. The power supply 9 is not switched by the supply voltage switch 4. In order to detect the switching position of the supply voltage switch 4, a first sensor circuit 10 and a second sensor circuit 11 of the switch-on protection device 1 are provided, with the sensor circuit 10 being directly connected to the supply voltage input 2 and the second sensor circuit 11 being connected at the output side with the supply voltage switch 4. Essentially, the sensor circuits 10, 11 comprise RC elements.

The first sensor circuit 10 and the second sensor circuit 11 are followed by an electronic switching element 12 with two signal inputs that are connected to the RC elements of the sensor circuits 10, 11. The electronic switching element 12 is a flip-flop, preferably a D-flip-flop. The RC elements of the sensor circuits 10, 11 have different dimensions and delay the signals picked up at the output side of the supply voltage switch 4 and at the supply voltage input 2 for different periods of time.

The signal provided by the first sensor circuit 10 is applied to a data input D and the signal originating at the second sensor circuit 11 is applied to the clock input CP of the flip-flop 12. With a positive edge of the signal at the clock input CP, the value of the data input D is switched to a data output Q. The value at the data output Q of the flip-flop depends on whether, at the edge of the clock input CP, a signal is already present at the data input D, i.e. which of the two signals of the sensor circuits 10, 11 is applied as the first one to the signal inputs D, CP. In particular the switching element 12 issues a logic state 1 or 0 at its data output Q that depends on whether the supply voltage is applied to the supply voltage input 2 with the supply voltage switch 4 switched ON or OFF.

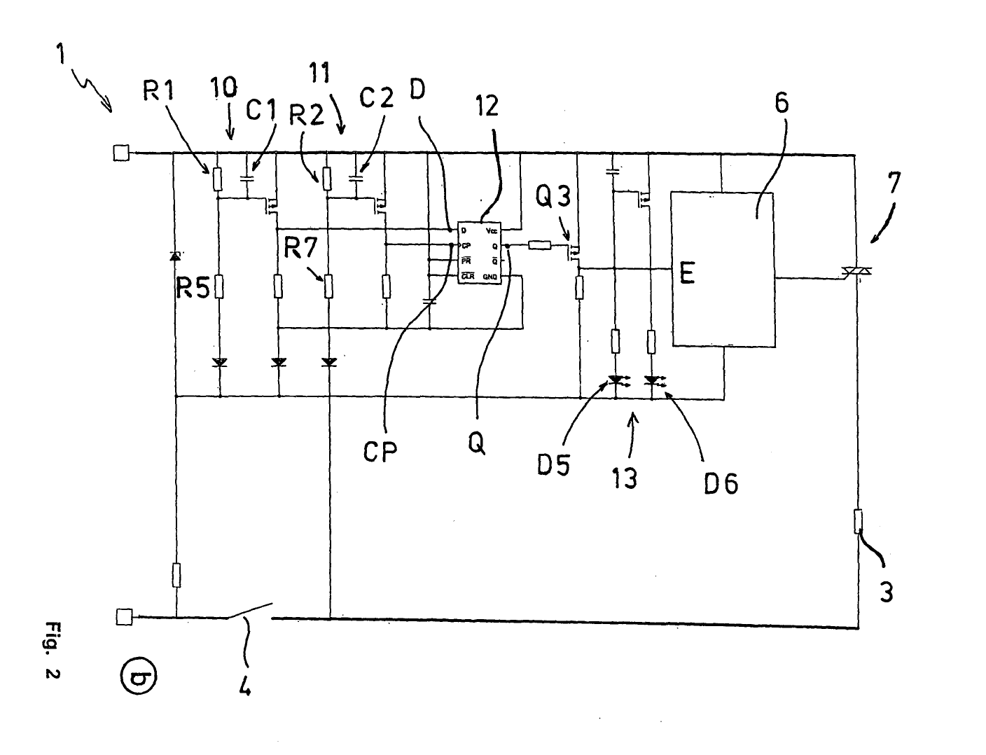

The data output Q of the flip-flop 12 is connected to a signal input E of the electronic control system 8 of the semiconductor switching device 6. The output signal of the flip-flop 12 that is present at the data output Q is made available directly or indirectly for processing to the electronic control system 8 via a driver transistor that is shown only in FIGS. 2a, 2b. Depending on a value of 0 or 1 of the output signal, the electronic control system 8 either connects the supply voltage current path through to the load 3 via the semiconductor switch 7, or not. The “0” value or the “1” value depend on whether the switch-on protection device 1 operates with a positive or a negative logic. With a logic power provided negatively, the normal signal output is Q, where the output signal corresponds to the input signal; when a positive logic is chosen, the inverted signal output Q′ of the D-flip-flop 12 is connected to the signal output E of the semiconductor switch 6.

In addition, the switch-on protection device 1 also comprises an electro-optical display 13 in the form of two LEDs that shows whether the semiconductor switch 7 is open or closed and whether the switch-on protection device 1 may have prevented the closing of the semiconductor switch 7. The display 13 is connected to the switching element 12 and the electronic control system 8 where the associated information is available as voltages that can be tapped.

By way of examples, the FIGS. 2a, 2b show two possible electronic circuits for the switch-on protection device 1 with reference to electrical diagrams. FIG. 2a shows a switch-on protection device with a positive logic, and FIG. 2b shows one with a negative logic. The variant with a negative logic also comprises the electro-optical display 13 that displays the state of the switch-on protection device 1 to the operator by means of two LEDs. The circuit is not described in detail because it is easily understood by a person skilled in the art.

In the positive logic, the line voltage switched by the supply voltage switch 4 is positive in relation to the neutral potential; in the negative logic, it is negative in relation to the neutral potential. The different signal edges of the input signals for the data input D and the clock input CP of the flip-flop 12 are determined by the resistors R5 or R7, and the different delays of the input signals for the data input D and the clock input CP are determined by the RC elements R5, R1, C1 and R7, R2, C2, respectively. In FIG. 2a, the inverted signal output Q′, and in FIG. 2b the non-inverted signal output Q, is connected to the signal input E of the semiconductor switch 6. If the inverted signal input Q′ is tapped at the D-flip-flop 12, the value “1” on Q′ means that the switch-on protection device 1 has reacted and that the load 3 must not be connected, and the value “0” means that the switch-on protection device 1 has not reacted and the load 3 may be connected. Accordingly, the signal input E of the semiconductor switch 6 may also have the designation RUN. In the negative logic, where the non-inverted signal output Q is tapped at the D-flip-flop 12, the meaning of the values “0” and “1”, respectively, is reversed, so that the signal input E of the semiconductor switch 6 may also have the designation STOP. The signal output Q or Q′, respectively, is connected to the signal input E of the semiconductor switching device 6 via a MOSFET Q3 or Q1, respectively. The electro-optical display 13 is formed by a red LED D5 and a green LED D6 along with suitable circuitry, with the LEDs indicating the reaction of the switch-on protection device 1 or the correct functioning of the electrical device.

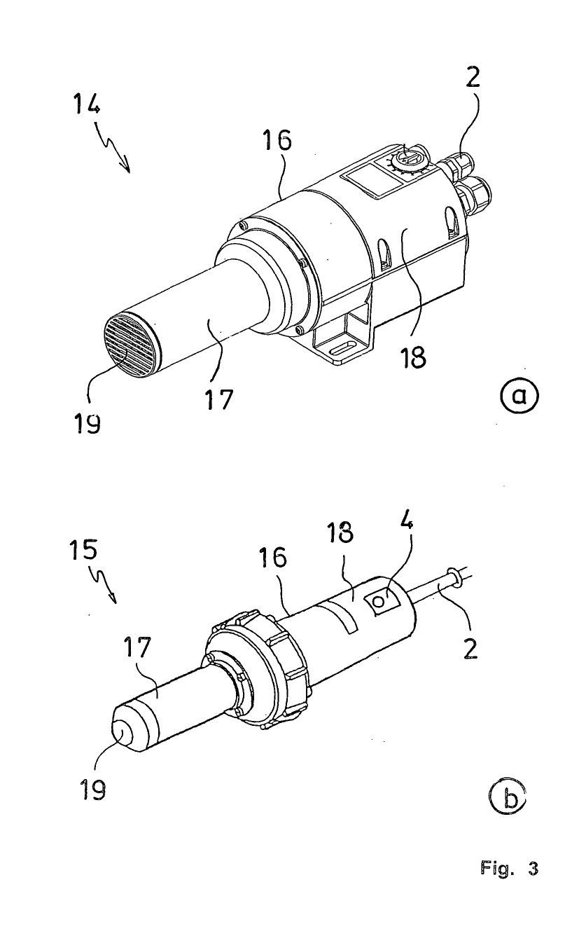

The FIGS. 3a, 3b show two embodiments of hot air devices 14, 15 according to the invention. The hot air device 14 shown in FIG. 3a is a device without a plug connector that can be flanged to a machine frame and is intended for a hard-wired connection to the supply voltage. The hot air device 15 shown in FIG. 3b is equipped with a power cord with a plug connector (not shown). Other than that, the two devices 14, 15 are substantially equipped identically.

The hot air devices 14, 15 have a housing 16 with a rear housing section 18 and a front heating tube 17 which houses a switchable load in the form of a heating device that is not visible from the outside. The air heated by the heating device exits from the heating tube 17 at the air outlet 19. Via a supply voltage switch 4 that is connected electrically in series with the supply voltage input 2 and the heating device, supply voltage is supplied to the heating device. In the device 15, the supply voltage switch 4 is arranged at the rear housing section 18 and can be actuated manually. By means of the supply voltage switch 4, supply voltage applied to the supply voltage input 2 can be switched through to the heating device. The switch-on protection device according to the invention is installed in the rear housing section 18. It is not visible from the outside and acts as described above. In the device 14, the supply voltage switch is arranged at the rear of the housing 16, or separate from the housing 16 in an electric supply line or in an electric panel, and is not shown in the drawing.

1. A switch-on protection device for an electrical device that can be operated on a supply voltage, comprising a supply voltage input, at least one switchable electric load and a supply voltage switch arranged in between that can be manually actuated and has the switching positions OFF and ON, where the switch-on protection device is arranged in a supply voltage current path from the supply voltage input to the load and detects the switching position of the supply voltage switch when the supply voltage is applied to the supply voltage input, and where it allows the closing of the supply voltage path to the electric load only in the OFF switching position of the supply voltage switch, with the switch-on protection device comprising a first sensor circuit, a second sensor circuit, and an electronic switching element with two signal inputs and with one signal output, where the first sensor circuit provides a first output signal that is derived from the supply voltage current path on the input side of the supply voltage switch, and where the second sensor circuit provides a second output signal that is derived from the supply voltage current path on the output side of the supply voltage switch, and where the output signal of the sensor circuits in each case is associated with one of the signal inputs of the switching element as input signal, and where the switch-on protection device comprises a semiconductor switching device that is connected to the signal output of the switching element and switches the supply voltage current path between the supply voltage input and the load downstream from the supply voltage switch in dependence on a switching signal issuing from the signal output, wherein the signal output of the electronic switching element may assume two stable states that can be reversed by a change of the input signals at the two signal inputs.

2. The switch-on protection device according to claim 1, wherein the first sensor circuit comprises a first, and the second sensor circuit comprises a second RC element that apply signals tapped at the input or the output side of the supply voltage switch with different periods of delay to the signal inputs of the switching element.

3. The switch-on protection device according to claim 1, wherein the switching signal issuing from the signal output depends on which one of the output signals of the sensor circuits is applied as the first input signal to the signal inputs.

4. The switch-on protection device according to claim 1, wherein the switching element is a flip-flop, preferably a D-flip-flop with a data input (D) and a clock input (CP).

5. The switch-on protection device according to claim 4, wherein at the data input of the flip-flop the signal tapped at the supply voltage input is applied, and that at the clock input the signal tapped at the output side of the supply voltage switch is applied.

6. The switch-on protection device according to claim 1, wherein an electro-optical display is provided that indicates to which signal input of the switching element a signal was applied first when the supply voltage was applied to the supply voltage input.

7. A hot get air device that can be operated on a supply voltage and comprises at least one supply voltage input, at least one switchable electric load in the form of a heating device, and one supply voltage switch for switching the electric load that can be actuated manually and is arranged in series with the supply voltage input and the heating device, comprising a switch-on protection device according to claim 1.
